(19) United States
(12) Patent Application Publication
(10) Pub. No.: US 2017/0343926 A1
(43) Pub. Date: Nov. 30, 2017

(54) DEVELOPING DEVICE

(71) Applicant: CANON KABUSHIKI KAISHA, Tokyo (JP)

(72) Inventor: Toshihisa Yago, Toride-shi (JP)

(21) Appl. No.: 15/604,968

(22) Filed: May 25, 2017

(30) Foreign Application Priority Data
May 27, 2016 (JP) 2016-106743

(51) Int. Cl. G03G 15/08; G03G 9/107

(52) U.S. Cl. CPC G03G 15/0829; G03G 15/0865; G03G 15/0891; G03G 9/107; G03G 2215/083; G03G 2215/0888; G03G 2215/0607

(57) ABSTRACT

A developing device includes a developing container, a detecting unit including a base portion and a detecting portion, a feeding path, a feeding screw, and a recessed portion provided on a side wall of the developing container. The recessed portion is disposed so as to project toward the feeding screw in the feeding path. The side wall includes a projected region projected toward the screw portion in the feeding path by the recessed portion and a region other than the projected region. The feeding screw includes a first screw portion opposing the projected region and a second screw portion opposing the region other than the projected region. The first screw portion includes a rotation shaft which includes a portion having a shaft diameter smaller than a shaft diameter of a rotation shaft of the second screw portion.

### FIELD OF THE INVENTION AND RELATED ART

The present invention relates to a developing device.

The developing device includes a detecting unit including a base portion and a detecting portion, provided on the base portion, for detecting a toner content of a developer accommodated in a developing container. A (magnetic) permeability sensor (inductance sensor) which is an example of the detecting unit detects the toner content by detecting permeability of the developer accommodated in the developing container.

In the case where the permeability sensor is provided at a bottom, of the developing container which is a portion where an immobile layer of the developer fed in the developing container is liable to generate, there is a liability that an error generates in a detection result of the toner content. Therefore, a constitution in which the permeability sensor is provided on a side wall, of the developing container, which is a portion where the immobile layer of the developer fed in the developing container does not readily generate is disclosed (Japanese Laid-Open Patent Application (JP-A) 2006-195326).

In the case where the permeability sensor is provided on the side wall of the developing container in an image forming apparatus of a so-called tandem type in which a plurality of image forming portions each including a photosensitive drum, a developing device and the like are juxtaposed, in order to ensure a space for permitting placement of the permeability sensor in the side wall of the developing container, it is desirable that an interval between adjacent image forming portions is increased, but upsizing of the image forming apparatus is invited.

In the developing device of JP-A 2006-195326, a recessed portion for mounting the permeability sensor is provided on the side wall of the developing container, and then the permeability sensor is mounted in a state that a part of the permeability sensor enters the recessed portion. In such a constitution, a cross-sectional area of a feeding path, for feeding the developer, in a region opposing the recessed portion of the side wall of the developing container is smaller than a cross-sectional area of the feeding path in a region other than the region opposing the recessed portion.

Further, in the developing device of JP-A 2006-195326, a blade diameter of a blade portion of a feeding screw at a portion opposing the recessed portion of the side wall of the developing container is made smaller than that at a portion other than the portion opposing the recessed portion. However, in the case where the constitution as disclosed in JP-A 2006-195326 is employed, due to a decrease in blade diameter of the blade portion of the feeding screw at the portion opposing the recessed portion of the side wall of the developing container, there is a liability that the decrease in blade diameter of the blade portion has the influence on a developer feeding property of the feeding screw. Therefore, in order to reduce a degree of the influence on the developer feeding property of the feeding screw, a developer feeding force of the feeding screw at the portion opposing the recessed portion of the side wall of the developing container is required to be ensured to some extent.

Therefore, a new constitution in which the detecting unit for detecting the toner content of the developer accommodated in the developing container is provided on the side wall of the developing container and in which the degree of the influence on the developer feeding property of the feeding screw is reduced while realizing downsizing of the developing device has been desired.

### SUMMARY OF THE INVENTION

A principal object of the present invention is to provide a developing device having a constitution in which a detecting unit for detecting a toner content of a developer accommodated in a developing container is provided on a side wall of the developing container and in which a degree of an influence on a developer feeding property of a feeding screw is reduced while realizing downsizing of the developing device.

According to an aspect of the present invention, there is provided a developing device comprising: a developing container configured to accommodate a developer containing toner and a magnetic carrier; a detecting unit including a base portion and a detecting portion provided on the base portion and configured to detect a toner content of the developer accommodated in the developing container; a feeding path configured to feed the developer; a feeding screw configured to feed the developer accommodated in the developing container, the feeding screw being provided in the feeding path and including a rotation shaft and a helical blade portion provided on an outer peripheral surface of the rotation shaft; and a recessed portion provided on a side wall of the developing container and configured to mount the detecting unit, wherein the recessed portion is disposed so as to project toward the feeding screw in the feeding path, wherein the side wall includes a projected region projected toward the screw portion in the feeding path by the recessed portion and a region other than the projected region, and wherein the feeding screw includes a first screw portion opposing the projected region and a second screw portion opposing the region other than the projected region, the first screw portion including a rotation shaft which includes a portion having a shaft diameter smaller than a shaft diameter of a rotation shaft of the second screw portion.

Further features of the present invention will become apparent from the following description of exemplary embodiments with reference to the attached drawings.

### BRIEF DESCRIPTION OF THE DRAWINGS

FIG. 1 is a schematic view showing of a structure of an image forming apparatus to which a developing device according to an embodiment of the present invention is applied.

FIG. 2 is a sectional view showing the developing device in the embodiment.

FIG. 3 is a top plan view showing the developing device in a horizontal cross section including an axial direction.

FIG. 4 is a perspective view showing an appearance of a (magnetic) permeability sensor.

FIG. 5 is a schematic view for illustrating a detection principle of the sensor.

FIG. 6 is a circuit view showing a sensor circuit.

FIG. 7 is a schematic view for illustrating an arrangement of the sensor.

FIG. 8 is an enlarged top view showing a part of the sensor and a feeding screw in the embodiment.

FIG. 9 is a sectional view showing another example of a recessed portion.

### DESCRIPTION OF THE EMBODIMENTS

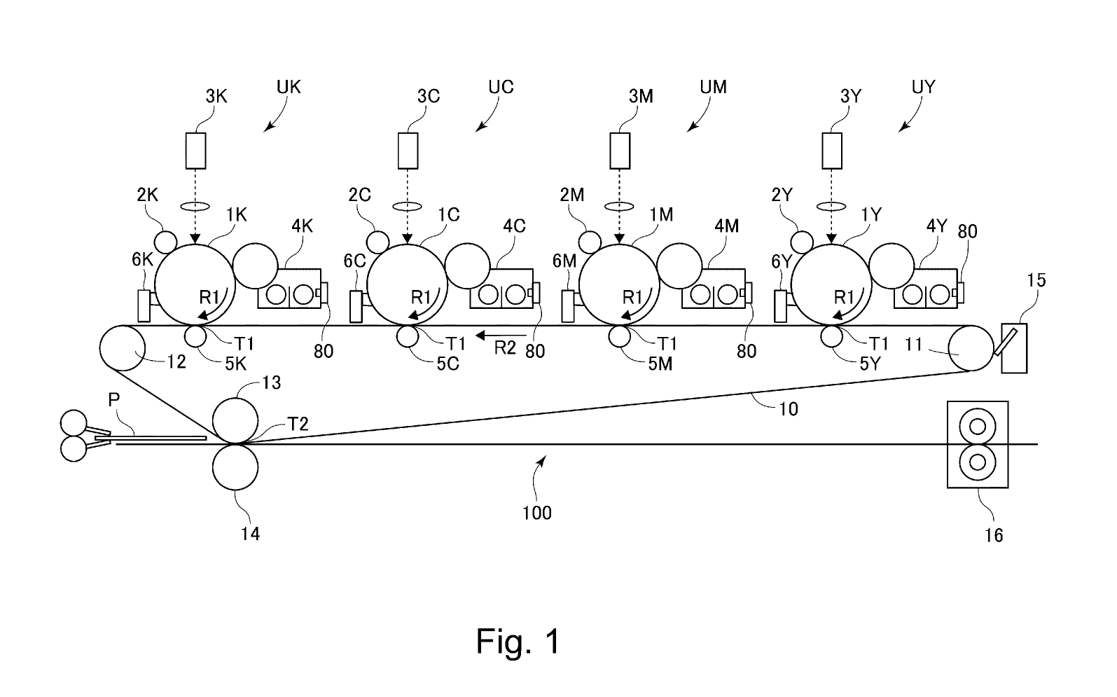

A developing device according to an embodiment of the present invention will be described. First, a general structure of an image forming apparatus to which the developing device according to the present invention is applied will be described with reference to FIG. 1. An image forming apparatus 100 shown in FIG. 1 is an intermediary transfer type full-color printer of a tandem type in which image forming portions UY, UM, UC and UK are arranged along an intermediary transfer belt 10.

### <Image Forming Portion>

At the image forming portion UY, a yellow toner image is formed on a photosensitive drum 1Y and then is transferred onto the intermediary transfer belt 10. At the image forming portion UM, a magenta toner image is formed on a photosensitive drum 1M and then is transferred onto the intermediary transfer belt 10. At the image forming portion UC and UK, cyan and black toner images are formed on photosensitive drums 1C and 1K respectively, and then are transferred onto the intermediary transfer belt 10. The four color toner images transferred on the intermediary transfer belt 10 are fed to a secondary transfer portion T2 and are secondary-transferred together onto a recording material P (sheet material such as a sheet or an OHP sheet).

The image forming portions UY, UM, UC and UK have the substantially same constitution except that colors of toners used in developing devices 4Y, 4M, 4C and 4K, respectively, are yellow, magenta, cyan and black, respectively. In the following, constituent element of the image forming portions are represented by reference numerals or symbols from which suffixes Y, M, C and K for representing a difference in color for the image forming portions UY, UM, UC and UK are omitted, and constitutions and operations of the image forming portions UY to UK will be described.

The image forming portion U includes, at a periphery of the photosensitive drum 1 as an image bearing member, a primary charger 2, an exposure device 3, the developing device 4, a primary transfer roller 5 and a drum cleaning blade 6. The photosensitive drum 1 is prepared by forming a photosensitive layer on an outer peripheral surface of an aluminum cylinder, and is rotated in an arrow R1 direction in FIG. 1 at a predetermined process speed.

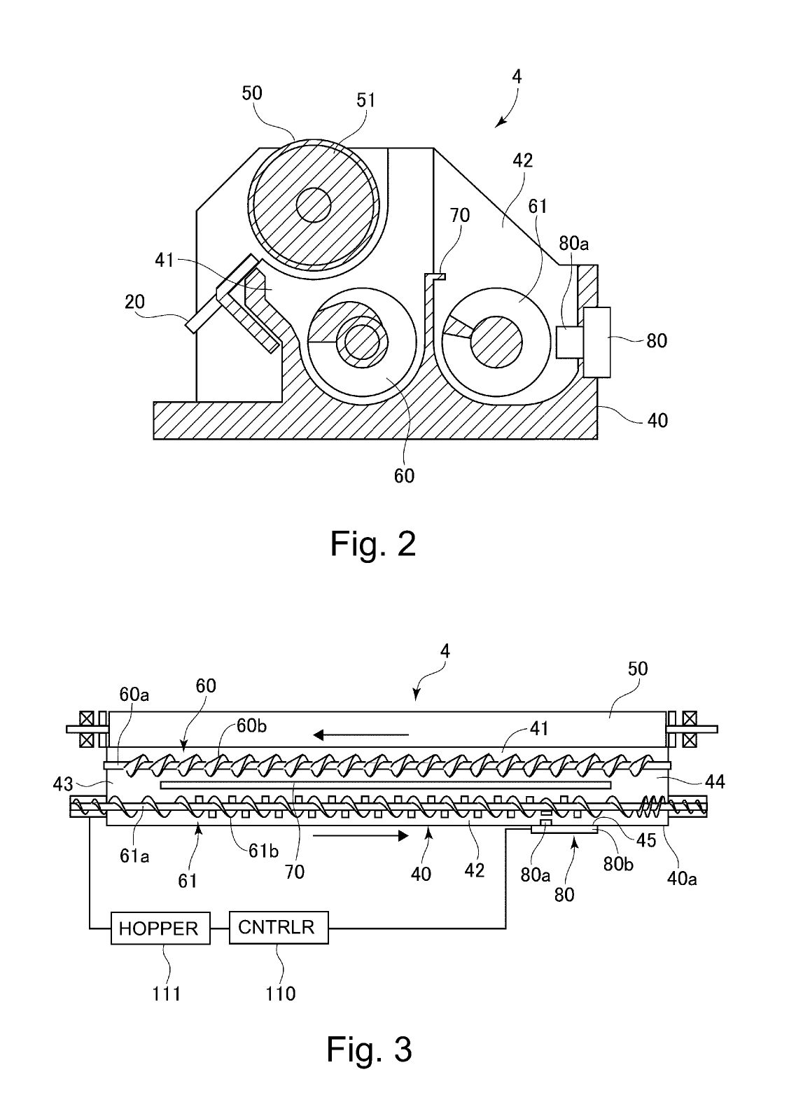

The charger 2 is, for example, a charging roller formed in a roller shape, and electrically charges the photosensitive drum 1 to a uniform negative dark-portion potential in contact with the photosensitive drum 1 under application of a charging bias voltage. The exposure device 3 generates a laser beam, from a laser beam emitting element, obtained by subjecting scanning line image data which is developed from an associated color component image to ON-OFF modulation and then to scanning through a rotating mirror, so that an electrostatic image for an image is formed on the surface of the charged photosensitive drum 1. The developing device 4 supplies the toner to the photosensitive drum 1 and develops the electrostatic image into the toner image. The developing device 4 will be described later (FIGS. 2 and 3).

The primary transfer roller 5 is disposed opposed to the photosensitive drum 1 via the intermediary transfer belt 10 and forms a toner image primary transfer portion T1 between the photosensitive drum 1 and the intermediary transfer belt 10. By applying a transfer voltage from a high-voltage source (not shown) to the primary transfer roller 5 at the primary transfer portion T1, the toner image is primary-transferred from the photosensitive drum 1 onto the intermediary transfer belt 10.

A primary transfer residual toner slightly remaining on the photosensitive drum 1 after the primary transfer is removed by the cleaning blade 6. The cleaning blade 6 is a plate-like member which is formed of a non-magnetic material such as polyurethane and which has elasticity. The cleaning blade 6 is disposed downstream of the primary transfer portion T1 and upstream of the primary charger 2 with respect to a rotational direction of the photosensitive drum 1, and is provided so as extend along a rotational axis direction (longitudinal direction) of the photosensitive drum 1.

The intermediary transfer belt 10 is extended around and supported by a driving roller 11, a tension roller 12, an inner secondary transfer roller 13 and the like, and is driven by the driving roller 11, so that the intermediary transfer belt 10 is rotated in an arrow R2 direction in FIG. 1. A secondary transfer portion T2 is a toner image transfer nip where the toner image is transferred onto a recording material P formed by contact of an outer secondary transfer roller 14 with the intermediary transfer belt 10 supported by the inner secondary transfer roller 13. At the secondary transfer portion T2, by applying a secondary transfer voltage to the outer secondary transfer roller 14, the toner image is secondary-transferred from the intermediary transfer belt 10 onto the recording material P fed to the secondary transfer portion T2. A secondary transfer residual toner remaining on the intermediary transfer belt 10 while being deposited on the intermediary transfer belt 10 is removed by a belt cleaning device 15 by rubbing the intermediary transfer belt 10 with a cleaning blade.

The recording material P on which the four color images are secondary-transferred at the secondary transfer portion T2 is fed to a fixing device 16. The fixing device 16 melt-fixes the toner image on the recording material P under application of pressure by two rollers or two belts which oppose each other and under application of heat by a heat source (not shown) such as a heater in general. The recording material P on which the toner image is fixed by the fixing device 16 is discharged to an outside of the image forming apparatus 100.

### <Developing Device>

The developing device 4 in this embodiment will be described using FIGS. 2 and 3. The developing device 4 includes, as shown in FIG. 2, a regulating blade 20, a developing container 40 forming a housing, a developing sleeve 50 as a developer carrying member, a developing screw 60 as a first feeding means, a stirring screw 61 as a second feeding means, and the like.

In the developing container 40, a two-component developer containing a non-magnetic toner and a magnetic carrier is accommodated. That is, this embodiment employs a two-component developing system as a developing system and uses the developer in which a negatively chargeable non-magnetic toner and a positively chargeable magnetic carrier are mixed. The non-magnetic toner is obtained by incorporating a colorant, an external additive such as colloidal silica fine powder, and a wax or the like into a resin material such as polyester resin or styrene-acrylic resin, and is formed in a powdery form by pulverization or polymerization. The magnetic carrier is obtained by coating a resin material on a surface layer of a core formed of ferrite particles or resin particles kneaded with magnetic powder. A toner content (TD ratio) of the developer in an initial state is 8%, for example.

The developing container 40 is open at a part thereof opposing the photosensitive drum 1 (FIG. 1), and as shown in FIG. 2, the developing sleeve 50 is provided rotatably in the developing container 40 so as to be partly exposed through an opening of the developing container 40. The developing sleeve 50 is formed in a cylindrical shape using a non-magnetic material such as aluminum or stainless steel and is rotated in the same direction as the photosensitive drum 1 at an opposing surface to the photosensitive drum 1. Inside the developing sleeve 50, a magnet roller 51 as a magnetic field generating means is fixedly provided. By a magnetic force of the magnet roller 51, on the surface of the developing sleeve 50, a magnetic chain of the developer is formed. A layer thickness of the magnetic chain formed on the surface of the developing sleeve 50 is regulated by a regulating blade 20 and the magnetic chain is sent to a predetermined developing region. The regulating blade 20 is a plate-like member formed of a non-magnetic material, and is provided along a rotational axis direction (longitudinal) direction of the developing sleeve 50. The magnetic chain sent to the developing region rubs the photosensitive drum 1, so that the electrostatic latent image formed on the photosensitive drum 1 is developed into the toner image.

An inside of the developing container 40 is partitioned with respect to a horizontal direction into a left-side developing chamber 41 and a right-side stirring chamber 42 in FIG. 2 by a partition wall 70 extending in a vertical direction at a substantially central portion. As shown in FIG. 3, the developing chamber 41 and the stirring chamber 42 communicate with each other through first and second communicating portions 43 and 44 provided at both end portions of the partition wall 70, and form a circulation path of the developer.

In the developing chamber 41 as a first chamber and the stirring chamber 42 as a second chamber, a developing screw 60 and a stirring screw 61 are rotatably provided, respectively. The developing screw 44 and the stirring screw 45 have screw structures including blades 60b and 61b formed spirally around rotation shafts 60a and 61a, respectively.

The developing screw 60 is disposed substantially parallel in the developing container 41 along the rotational axis direction of the developing sleeve 50, and the stirring screw 61 is disposed substantially parallel to the developing screw 60 in the developing container 41. The developing screw 60 and the stirring screw 61 may only be required to be disposed so as to at least partly overlap with each other as seen in a horizontal direction. In this embodiment, the developing screw 60 and the stirring screw 61 are disposed so as to be arranged in the horizontal direction (FIG. 2).

The developing sleeve 50, the developing screw 60 and the stirring screw 61 are constituted so as to be connection-driven via unshown gear trains, and are rotated via the gear trains from an unshown driving motor. When the developing screw 60 is rotated, the developer in the developing container 41 is fed from a right side toward a left side in FIG. 3 along the rotation shaft 60a of the developing screw 60. The developer fed in the developing chamber 41 is delivered from the developing chamber 41 to the stirring chamber 42 through the first communicating portion 43. On the other hand, when the stirring screw 61 is rotated, the developer in the developing container 41 is fed from the left side toward the right side in FIG. 3, i.e., in a direction opposite to a developer feeding direction in the developing chamber 41. The developer fed in the stirring chamber 42 is delivered from the stirring chamber 42 to the developing chamber 41 through the second communicating portion 44. The developer thus fed by the developing screw 60 and the stirring screw 61 while being stirred by the screws are charged so that the toner is negatively charged and the carrier is positively charged.

### <ATR Control>

In the image forming apparatus 100, the toner charge amount has the influence on the image density, but is correlated with the toner content. Therefore, in order to maintain the toner content of the developer in the developing container 40 with in a predetermined range, automatic toner replenishment (ATR) control is carried out by a controller 110. When the ATR control is carried out, toner in an amount corresponding to an amount of the toner consumed during image formation is supplied from a hopper 111 to the developing container 40. The controller 110 calculates a toner consumption amount for a single recording material P from a density, an area or the like of the image subjected to the image formation, for example, and can acquire a toner supply amount, which is a proper amount, depending on the toner content detected using a permeability sensor (inductance sensor) described below.

### <Permeability Sensor>

A (magnetic) permeability sensor 80 is used for detecting the toner content of the developer accommodated in the developing container 40. When the permeability sensor 80 is used, the ATR control can be carried out at any time even during the image formation, so that an efficient operation of the image forming apparatus 100 can be realized.

As shown in FIG. 3, the permeability sensor 80 is provided upstream of the communicating portion 44, for establishing communication between the stirring chamber 42 and the developing chamber 41, with respect to the developer feeding direction of the stirring screw 61. However, the permeability sensor 80 may preferably be provided in the stirring chamber 42 in a side close to the second communicating portion 44. This is because in a state that the toner supplied particularly during the ATR control is sufficiently stirred with an already-existing developer, the toner content of the developer is properly detected. Further, the permeability sensor 80 is provided in a state that a detecting portion 80a is exposed to an inside of the developing container 40, i.e., is provided so as to be buried in a side wall 40a, in a stirring chamber 42 side, opposing the partition wall 70 via the stirring screw 61 along the horizontal direction as specifically described later. Incidentally, from a viewpoint of ensuring flowability of the developer in a side wall 40a side where the permeability sensor 80 is provided, the stirring screw 61 may preferably be rotated so that the blade 61b rises in the side wall 40a side.

The permeability sensor 80 as a detecting means outputs, an output value depending on a change in (magnetic) permeability of the developer by using an inductance of a coil. In the permeability sensor 80, in the case where the toner content of the developer decreases, a proportion of the magnetic carrier contained in the developer in a unit volume becomes large and apparent permeability of the developer becomes high, so that the output value becomes high. On the other hand, in the case where the toner content of the developer increases, the proportion of the magnetic carrier contained in the developer in the unit volume becomes small and the apparent permeability of the developer becomes low, so that the output value becomes low.

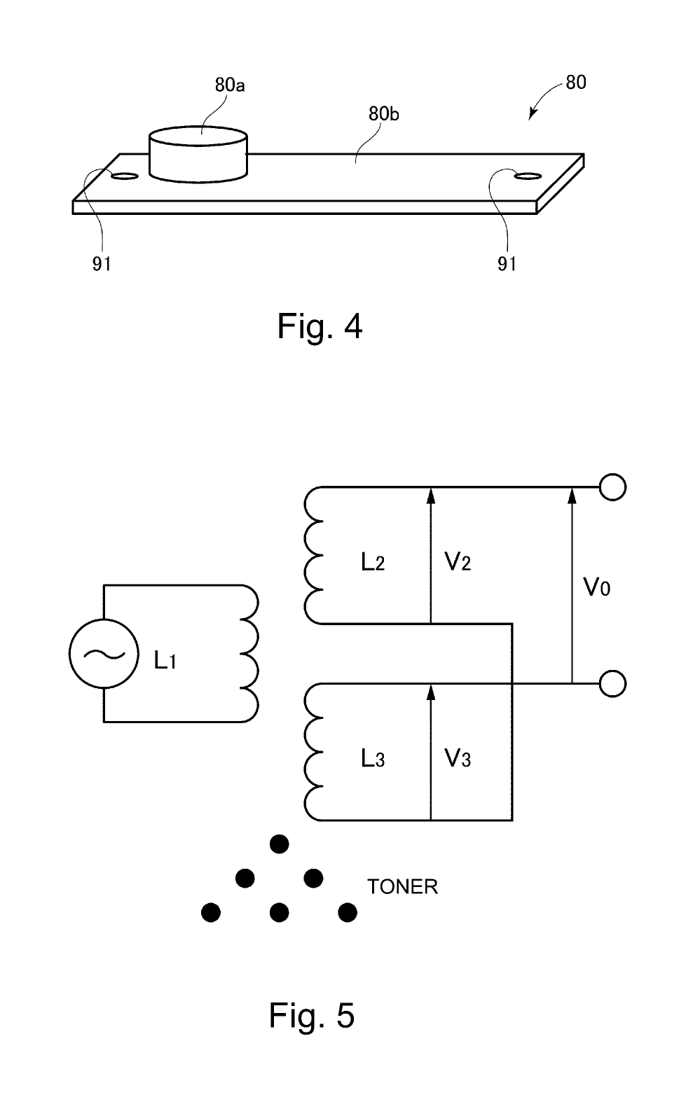

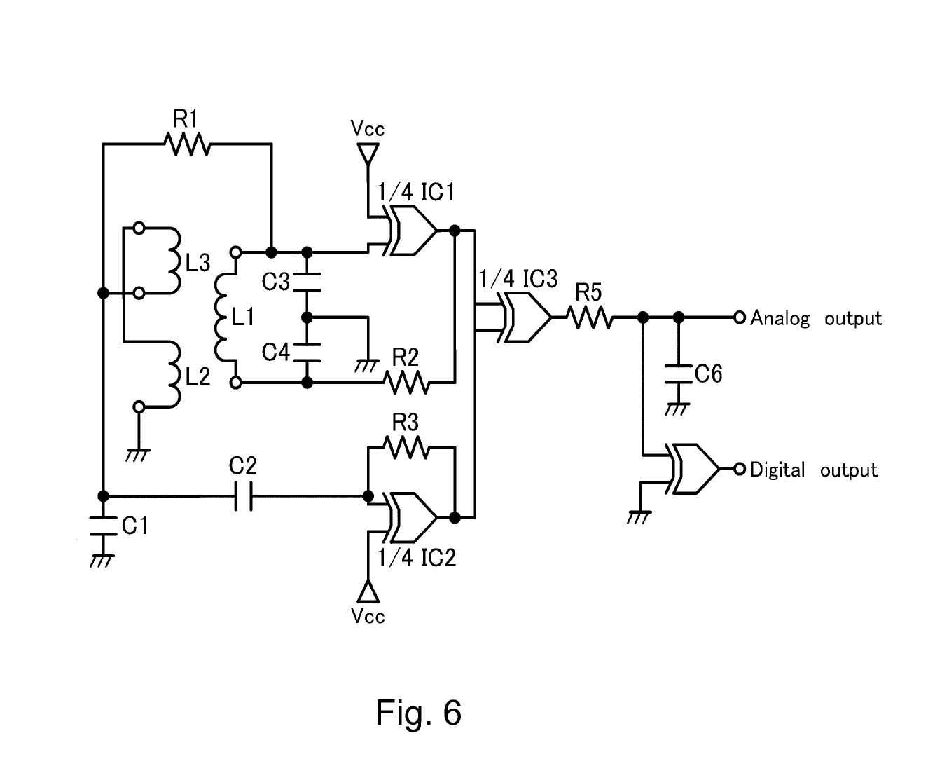

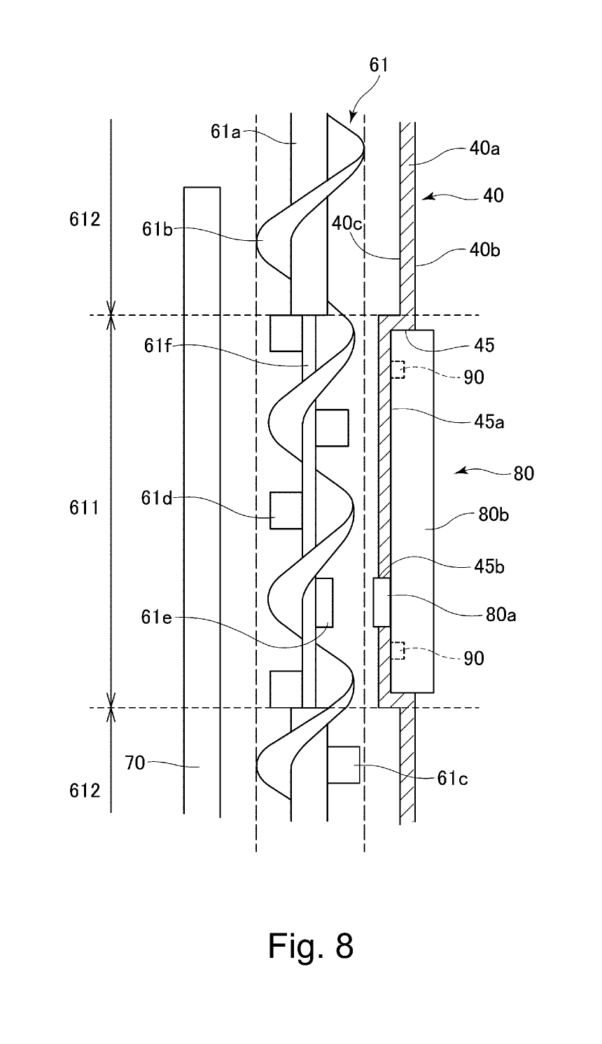

FIG. 4 is a perspective view showing an outer appearance of the permeability sensor 80. As shown in FIG. 4, the permeability sensor 80 can be roughly divided into a cylindrical detecting portion 80a and a plate-like substrate portion (base portion) 80b. The detecting portion 80a projects from the substrate portion 80b, and at the substrate portion 80b, coils (a driving coil, a detecting coil and a reference coil shown in FIG. 6) for forming a magnetic field depending on energization are provided. The detecting portion 80a is formed in, for example, about 4 mm in height from the substrate portion 80b and about 8 mm in diameter. On the other hand, the substrate portion 80b includes electronic components (a capacitor, a semiconductor integrated circuit (IC), a resister and the like shown in FIG. 6), of an LC oscillation circuit, other than the coils, and the electronic components are electrically connected with the coils of the detecting portion 80a. The permeability sensor 80 is mounted to the developing container 40 so that the detecting portion 80a is exposed to the inside of the developing container 40. The substrate portion 80b is provided with engaging holes 91 as portions-to-be-engaged for engaging with engaging projections 90 (FIG. 8 described later) as engaging portions provided in the developing container 40 side, and causes the permeability sensor 80 to be detachably mountable to the developing container 40.

FIG. 5 is a schematic view for illustrating a detection principle of the permeability sensor 80. In the case of this embodiment, as the permeability sensor 80, a permeability sensor employing a principle of a differential transformer was used. The differential transformer is constituted by providing a driving coil L1, a reference coil L2 and a detecting coil L3 on the same core, and the driving coil L1 is driven by an AC voltage with a high frequency (for example, 500 kHz), so that a voltage “V0=V2−V3” is differentially outputted. Here, a peak voltage of the reference coil L2 is represented by “V2”, and a peak voltage of the detecting coil L3 is represented by “V3”. For example, when the peak voltages of the detecting coil L3 and the reference coil L2 at an initial toner content (e.g., 8%) are “V30” and “V20”, respectively, as regards a voltage change “ΔV3” of the detecting coil L3, the permeability sensor 80 outputs “V0=V20−(V30+ΔV3)=−ΔV3”.

FIG. 6 shows an example of a circuit structure of the permeability sensor 80. The LC oscillation circuit shown in FIG. 6 includes, in addition to the coils (the driving coil L1, the reference coil L2, the detecting coil L3) constituting the above-described differential transformer, the electronic components such as the capacitor, the semiconductor IC, the resistor and the like. By employing the circuit structure shown in FIG. 6, the permeability sensor 80 outputs the voltage change “ΔV3” of the detecting coil L3 as it is as described above. The permeability sensor 80 is not limited to the permeability sensor having the circuit structure shown in FIG. 6, but may also be a permeability sensor having any circuit structure when the permeability sensor is capable of outputting a change in permeability of the developer.

In recent years, in order to further downsize the image forming apparatus 100 having the tandem structure, the plurality of image forming portions UY to UK including the developing devices 4Y to 4K are provided so that an interval between adjacent image forming portions is minimized. In this embodiment, the image forming portions UY to UK are disposed so that in the order from a left side in FIG. 1, an interval between the image forming portions UK and UC, an interval between the image forming portions UC and UM, and an interval between the image forming portions UM and IY are equal to each other and are narrowed to the extent possible.

The above-described controller 110 discriminates the toner content of the developer on the basis of the output value from the permeability sensor 80 depending on the change in permeability of the developer accommodated in the developing container 40. Further, in order to acquire a proper output value from the permeability sensor 80 depending on the change in permeability of the developer, there is a need to prevent the developer from stagnating in the neighborhood of the detecting portion 80a in the developing container 40. that is, when the developer stagnates in the neighborhood of the detecting portion 80a and forms in immobile layer, even if the toner is supplied into the developing container 40 with execution of the ATR control, replacement of the developer does not readily generate in the neighborhood of the detecting portion 80a, with the result that the toner content can be erroneously detected. Particularly, in the case where the permeability sensor 80 is provided at a bottom or a corner of the developing container 40, the erroneous detection of the toner content was conspicuous.

In view of the above, even in the case of the image forming apparatus 100 having the tandem structure, the permeability sensor 80 may preferably be provided to the side wall 40a, of the developing container 40, where the developer does not readily stagnate, i.e., the flowability of the developer is high compared with the case of the permeability sensor 80 provided at the bottom or the corner of the developing container. However, as already described above, in the conventional developing device, when the intervals among the image forming portions UY to UK are narrowed in the case where the developing device is used in the image forming apparatus having the tandem structure, it was difficult to provide the permeability sensor 80 to the side wall 40a of the developing container 40.

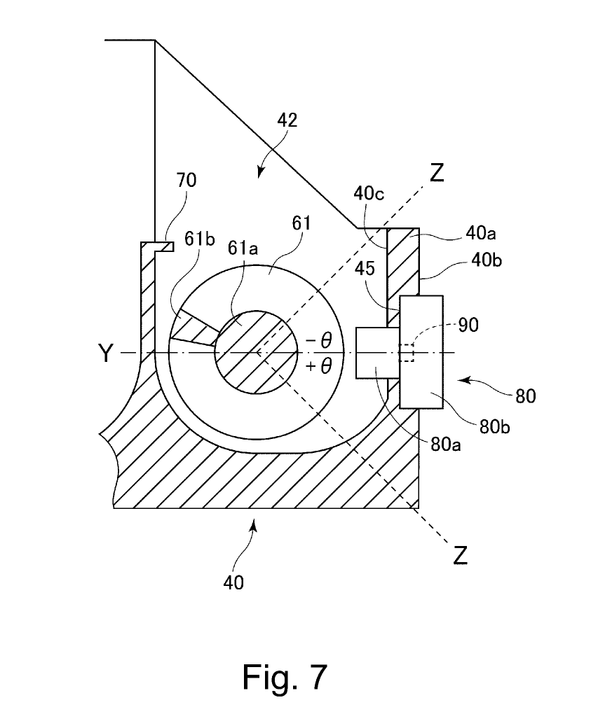

Therefore, as regards the developing devices 4Y to 4K, even when the intervals among the image forming portions UY to UK are relatively narrow, the permeability sensor 80 was constituted so as to be mounted to the side wall 40a of the developing container 40. This will be described using FIGS. 7 and 8.

As shown in FIG. 7, the permeability sensor 80 is provided so that the detecting portion 80a projects from the side wall 40a toward the stirring screw 61 side by, e.g., about 2 mm, in the stirring chamber 42 side. The detecting portion 80a is disposed so that a free end surface faces the rotation shaft 61a of the stirring screw 61. The permeability sensor 80 is provided so that an angle θ formed between a first rectilinear line (broken line Z in the figure) connecting a center of the detecting portion 80a with a rotational axis center of the stirring screw 61 and a second rectilinear line (chain line Y in the figure) passing through the rotational axis center of the stirring screw 61 in the horizontal direction falls within ±10 degrees. The angle θ formed between the first and second rectilinear lines may preferably be close to 0 degrees, and in FIG. 7, the case where the permeability sensor 80 is provided so that the angle θ between the first and second rectilinear lines is 0 degrees is shown as an example.

In this embodiment, in order to provide the permeability sensor 80 into the side wall 40a of the developing container 40, the side wall 40a of the developing container 40 is provided with a recessed portion 45 for holding the permeability sensor 80 so as to be detachably mountable to the side wall 40a. The recessed portion 45 is, as shown in FIG. 8, formed so that a part of an outer wall surface 40b of the side wall 40a is recessed toward an inside of the developing container 40 and so that a part of an inner wall surface 40c of the side wall 40a projects toward the inside of the developing container 40. The permeability sensor 80 is provided in the side wall 40a of the developing container 40 so as to enter the recessed portion 45.

The recessed portion 45 includes the engaging projections 90 projecting from a bottom portion 45a toward an outside of the developing container 40. Further, the recessed portion 45 is provided with an opening 45b, at the bottom portion 45a, through which the detecting portion 80a can enter the inside of the developing container 40. The engaging projections 90 engage in the engaging holes 91 (FIG. 4) formed in the substrate portion 80b of the permeability sensor 80, so that the permeability sensor 80 is held by the recessed portion 45. Then, the detecting portion 80a of the permeability sensor 80 is caused to enter the opening 45b, so that the permeability sensor 80 is held by the recessed portion 45 in a state that the detecting portion 80a is exposed to the inside of the developing container 40. This is because when the detecting portion 80a is directly contacted to the developer in the developing container 40, the toner content can be detected with high accuracy. On the other hand, when the substrate portion 80b is directly contacted to the developer, the developer enters the substrate portion 80b, with the result that the toner content can be erroneously detected. Therefore, the substrate portion 80b is disposed outside the developing container 40 partitioned by the recessed portion 45 so as not to contact the developer in the developing container 40.

The recessed portion 45 may preferably be formed, as shown in FIG. 8, so that the bottom portion 45a is disposed to an inner portion of the developing container 40 than the inner wall surface 40c of the side wall 40a where the recessed portion 45 is not formed is. Further, a thickness of the bottom portion 45a of the recessed portion 45 and a thickness of the side wall 40a at a position where the recessed portion 45 is not formed may preferably be substantially equal to each other. As a result, weight reduction of the developing device 4 can be realized while maintaining strength of the developing container 40, and it is easy to integrally generate the developing container 40 including the recessed portion 45.

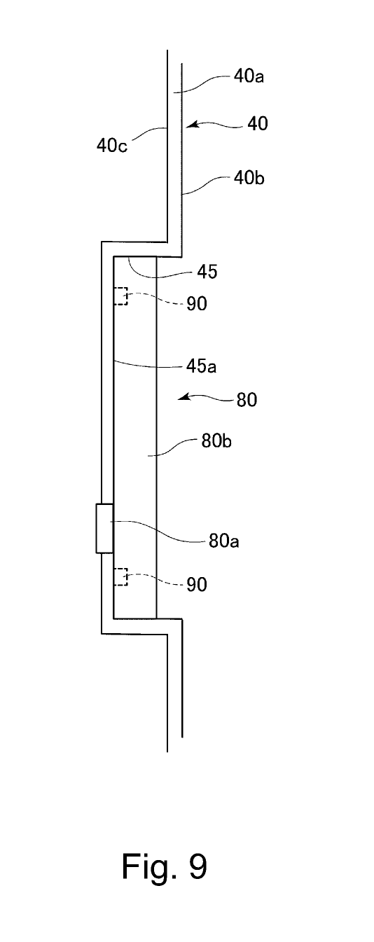

The recessed portion 45 may preferably be formed, as shown in FIG. 9, in a depth such that the substrate portion 80b of the permeability sensor 80 is buried in the side wall 40a, i.e., in a depth such that the permeability sensor 80 is accommodated in the recessed portion 45. Specifically, the permeability sensor 80 may preferably be provided at an inner position of the developing container 40 than the outer wall surface 40b of the side wall 40a where the recessed portion 45 is not formed is. For this purpose, the recessed portion 45 may preferably be formed so that a depth from the outer wall surface 40b to the bottom portion 45a is larger than the sum of the thicknesses of the detecting portion 80a and the substrate portion 80b of the permeability sensor 80. As a result, the permeability sensor 80 (substrate portion 80b) does not protrude from the outer wall surface 40b, and therefore, in the case where the developing device 4 in this embodiment is used in the image forming apparatus having the tandem structure, the interval between the image forming portion can be made narrower than that in the conventional developing device.

As described above, in this embodiment, the recessed portion 45 is formed so that a part of the inner wall surface 40c of the side wall 40a projects toward the inside of the developing container 40. However, when the inner wall surface 40c excessively projects toward the inside of the developing container 40, the recessed portion 45 and the stirring screw 61 are liable to interfere with each other. Therefore, there is a need to ensure a clearance between the recessed portion 45 (specifically the inner wall surface 40c) and the stirring screw 61 (specifically an outer edge portion of the blade 61b). For that purpose, it is only required that an outer diameter (screw diameter) of a first feeding portion 611, of the stirring screw 61, opposing the recessed portion 45 is made smaller than an outer diameter of a second feeding portion 612 other than the first feeding portion 611. Both of the first feeding portion 611 and the second feeding portion 612 may only be required that a clearance of, e.g., about 0.5 mm can be ensured between the inner wall surface 40c and the stirring screw 61.

As described above, in this embodiment, the outer diameter of the first feeding portion 611 is made smaller than the outer diameter of the second feeding portion 612, but there is a need to ensure an optimum developer circulating function at the first feeding portion 611 and the second feeding portion 612. Here, the optimum developer circulating function refers to a function such that a developer feeding amount per unit time (kg/h) is kept substantially uniform from an upstream side to a downstream side with respect to the developer feeding direction of the stirring screw 61. When the developer feeding amount is not uniform, with generation of localization of the developer in the stirring chamber 42 with respect to the developer feeding direction of the stirring screw 61, there is a possibility that the developer is not sufficiently stirred and the immobile layer of the developer generates, and therefore, it is important to ensure the optimum developer circulating function. Here, the developer feeding amount per unit time is represented by the following formula 1.

(Developer feeding amount)=60ηπ(D²−Ds²)pnρ/4 (formula 1)

In the formula 1, “η” is a filling ratio of the developer in the developing container 40 at a position of the detecting portion 80a of the permeability sensor 80 with respect to the developer feeding direction of the stirring screw 61. In this embodiment, for example, the filling ratio in a state that the stirring screw 61 is buried in the developer to a position of an upper-side outer edge portion of the blade 61b is 100%, and the filling ratio in a state that the stirring screw 61 is buried in the developer to a position of the center of the rotation shaft 61a is 50%. “ρ” is a bulk density of the developer at a position corresponding to the detecting portion 80a of the permeability sensor 80. “D” is the outer diameter of the stirring screw 61, “Ds” is a shaft diameter of the rotation shaft 61a of the stirring screw 61, “p” is a pitch of the blade 61b of the stirring screw 61 and “n” is the number of turns of the stirring screw 61.

By providing the recessed portion 45, the developer is liable to stagnate in the neighborhood of the recessed portion 45, particularly in the upstream side with respect to the developer feeding direction of the stirring screw 61. Further, when the developer feeding amount at the first feeding portion 611 is smaller than the developer feeding amount at the second feeding portion 612, the developer is more liable to stagnate at the first feeding portion 611. When the feeding of the developer stagnates, the developer is not sufficiently stirred, so that the immobile layer of the developer is liable to generate. Therefore, there is a need that the feeding of the developer is prevented from stagnating in the neighborhood of the recessed portion 45 by making the developer feeding amount at the first feeding portion 611 not less than the developer feeding amount at the second feeding portion 612. However, the developer feeding amount at the first feeding portion 611 may preferably be substantially equal to or somewhat larger than the developer feeding amount at the second feeding portion 612.

In order to make the developer feeding amount at the first feeding portion 611 not less than the developer feeding amount at the second feeding portion 612, (blade diameter/shaft diameter) (or (blade diameter)−(shaft diameter)) at the first feeding portion 611 may only be required to be made not less than (blade diameter/shaft diameter) (or blade diameter)−(shaft diameter)) at the second feeding portion 612. Here, the blade diameter is a length from an outer peripheral surface of the rotation shaft 61a to the outer edge portion of the blade 61a. In this embodiment, in order to form the stirring screw 61 so that the outer diameter at the first feeding portion 611 is smaller than the outer diameter at the second feeding portion 612, as shown in FIG. 8, the shaft diameter of the rotation shaft 61f at the first feeding portion 611 is made smaller than the shaft diameter of the rotation shaft 61 at the second feeding portion 612.

Incidentally, in order to make the outer diameter at the first feeding portion 611 smaller than the outer diameter at the second feeding portion 612, it would be also considered that the blade diameter of the blade 61b is decreased at the first feeding portion 611 without decreasing the shaft diameter of the rotation shaft 61f at the first feeding portion 611. However, in the case where the blade diameter of the blade 61b is decreased, compared with the case where the shaft diameter of the rotation shaft 61f is decreased, the developer feeding amount remarkably lowers, and therefore, it is difficult to ensure the optimum developer circulating function. Therefore, in this embodiment, the shaft diameter of the rotation shaft 61f was decreased without changing the blade diameter of the blade 61b. That is, the shaft diameter of the rotation shaft 61f at the first feeding portion 611 is smaller than the shaft diameter of the rotation shaft 61a at a “portion opposing a position immediately upstream of the recessed portion 45 with respect to the developer feeding direction in the stirring chamber 42” of the second feeding portion 612. Further, the shaft diameter of the rotation shaft 61f at the first feeding portion 611 is smaller than the shaft diameter of the rotation shaft 61a at the “portion opposing a position immediately downstream of the recessed portion 45 with respect to the developer feeding direction in the stirring chamber 42” of the second feeding portion 612.

Incidentally, the shaft diameter of the rotation shaft 61f at a “portion opposing the detecting portion 80a of the permeability sensor 80” of the first feeding portion 611 may preferably be smaller than the shaft diameter of the rotation shaft 61a at the second feeding portion 612. In a preferred example, the shaft diameter of the rotation shaft 61f at a “portion occupying 90% or more of the region opposing the recessed portion 45” is smaller than the shaft diameter of the rotation shaft 61a at the second feeding portion 612. Thus, the structures in the first feeding portion 611 are not employed in the second feeding portion 612, so that sufficient toner content uniformation is assured.

Further, as shown in FIG. 8, the stirring screw 61 includes, on a part (including the rotation shaft 61f) of the rotation shaft 61a, stirring ribs 61c to 61e each projecting in a radial direction of the rotation shaft 61a in an associated pitch of the blade 61b. Of these stirring ribs 61c to 61e, the stirring ribs 61d and 61e (first and third rib members opposing the recessed portion) at the first feeding portion 611 are formed in length, with respect to the radial direction of the rotation shaft 61a, shorter than the stirring rib (second rib member other than the first rib members) at the second feeding portion 612. Specifically, the stirring rib 61e (third rib member) opposing the detecting portion 80a of the permeability sensor 80 is formed in length, with respect to the radial direction of the rotation shaft 61a, shorter than the stirring rib 61d (first rib member) opposing the recessed portion 45 at a position other than a position opposing the detecting portion 80a. Further, the stirring rib 61d (first rib member) opposing the recessed portion 45 at the position other than the position opposing the detecting portion 80a is formed in length, with respect to the radial direction of the rotation shaft 61a, shorter than the stirring rib 61c (second rib member opposing the side wall 40a at a position other than a position opposing the recessed portion) at the second feeding portion 612.

As described above, the side wall 40a of the developing container 40 is provided with the recessed portion 45, and the permeability sensor 80 is provided to the developing container 40 so as to enter the recessed portion 45. The recessed portion 45 is formed so that the outer wall surface 40b as a part of the side wall 40a is recessed toward the inside of the developing container 40 and so that the inner wall surface 40c as a part of the side wall 40a is projected toward the inside of the developing container 40. That is, the permeability sensor 80 is provided so as to be buried in the side wall 40a. As a result, a protrusion amount of the permeability sensor 80 (specifically the substrate portion 80b) protruding from the outer wall surface 40b becomes smaller than that in the conventional developing device. Thus, when the developing device 4 in this embodiment is used in the image forming apparatus having the tandem structure, the permeability sensor 80 can be provided on the side wall 40a of the developing container 40 in which the immobile layer of the developer does not readily generate, without impairing downsizing of the image forming apparatus. Further, the permeability sensor 80 is disposed with reliability and facility at a predetermined position of the side wall 40a where the toner content can be properly detected.

### Other Embodiments

In the above-described Embodiment, the image forming apparatus having the constitution in which the toner images are primary-transferred from the photosensitive drums 1Y to 1K onto the intermediary transfer belt 10 and then the composite color toner images are secondary-transferred together onto the recording material P was described, but the present invention is not limited thereto. For example, an image forming apparatus of a direct transfer type in which the toner images are directly transferred from the photosensitive drums 1Y to 1K onto the recording material P carried and fed by a transfer material feeding belt may also be used.

In the above-described Embodiment, the developing device of the horizontal stirring type in which the developing container 40 is partitioned horizontally into the developing chamber 41 and the stirring chamber 42, but the present invention is not limited thereto. That is, the present invention is also applicable to a developing device of a vertical stirring type in which the developing container 40 is partitioned vertically into the developing chamber 41 and the stirring chamber 42.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-106743 filed on May 27, 2016, which is hereby incorporated by reference herein in its entirety.

What is claimed is:

1. A developing device comprising:
a developing container configured to accommodate a developer containing toner and a magnetic carrier;
a detecting unit including a base portion and a detecting portion provided on said base portion and configured to detect a toner content of the developer accommodated in said developing container;
a feeding path configured to feed the developer;
a feeding screw configured to feed the developer accommodated in said developing container, said feeding screw being provided in said feeding path and including a rotation shaft and a helical blade portion provided on an outer peripheral surface of said rotation shaft; and
a recessed portion provided on a side wall of said developing container and configured to mount said detecting unit,
wherein said recessed portion is disposed so as to project toward said feeding screw in said feeding path,
wherein said side wall includes a projected region projected toward said screw portion in said feeding path by said recessed portion and a region other than the projected region, and
wherein said feeding screw includes a first screw portion opposing the projected region and a second screw portion opposing the region other than the projected region, said first screw portion including a rotation shaft which includes a portion having a shaft diameter smaller than a shaft diameter of a rotation shaft of said second screw portion.

2. A developing device according to claim 1, wherein a blade diameter of a blade portion of said first screw portion is substantially equal to a blade diameter of a blade portion of said second screw portion.

3. A developing device according to claim 1, wherein the shaft diameter of the rotation shaft of said first screw portion at a portion opposing said detecting portion is smaller than the shaft diameter of the rotation shaft of said second screw portion.

4. A developing device according to claim 1, wherein the shaft diameter of the rotation shaft of said first screw portion is smaller than the shaft diameter of the rotation shaft of said second screw portion at a portion opposing a portion immediately upstream of the projected region with respect to a developer feeding direction of said feeding path.

5. A developing device according to claim 1, wherein the shaft diameter of the rotation shaft of said first screw portion is smaller than the shaft diameter of the rotation shaft of said second screw portion at a portion opposing a portion immediately downstream of the projected region with respect to a developer feeding direction of said feeding path.

6. A developing device according to claim 1, wherein the shaft diameter of the rotation shaft of said first screw portion is smaller than the shaft diameter of the rotation shaft over an entire region of said first screw portion.

7. A developing device according to claim 1, wherein a cross-section, of said developing device, perpendicular to a rotational axis of said feeding screw is seen, over an entirety of the projected region of said side wall, a distance from a rotation center of said first screw portion to an inner wall surface of said side wall in the projected region of said side wall is shorter than a distance from a rotation center of said second screw portion to an inner wall surface of said side wall in the region other than the projected region.

8. A developing device according to claim 1, wherein a cross-section, of said developing device, perpendicular to a rotational axis of said feeding screw is seen, over an entirety of the projected region of said side wall, a distance from a rotation center of said first screw portion to an outer wall surface of said side wall in the projected region of said side wall is shorter than a distance from a rotation center of said second screw portion to an inner wall surface of said side wall in the region other than the projected region.

9. A developing device according to claim 1, wherein said detecting unit is mounted in a state that an entire region of said base portion enters said recessed portion.

10. A developing device according to claim 1, wherein in the projected region of said side wall, an opening portion is provided, and
wherein said detecting unit is mounted in a state that said detecting portion enters said opening portion.

11. A developing device according to claim 1, wherein an outer diameter of said first screw portion is smaller than an outer diameter of said second screw portion.

12. A developing device according to claim 1, wherein said feeding screw is provided with a plurality of ribs formed so as to project from the rotation shaft in a radial direction, and
wherein a length of the rib at said first screw portion from the rotation shaft of said first screw portion in the radial direction is shorter than a length of the rib at said second screw portion from the rotation shaft of said second screw portion in the radial direction.

13. A developing device according to claim 1, wherein a developer feeding amount per unit time at said first screw portion is substantially equal to a developer feeding amount per unit time at said second screw portion.

14. A developing device according to claim 1, wherein a cross-section, of said developing device, perpendicular to a rotational axis of said feeding screw is seen, said detecting unit is mounted so that an angle formed by a rectilinear line connecting a rotation center of said feeding screw with a center of said detecting portion and a rectilinear line passing through the rotation center of said detecting portion in a horizontal direction is 10 degrees or less.

15. A developing device according to claim 1, wherein a thickness of said side wall in the projected region of said side wall is substantially equal to a thickness of said side wall in the region other than the projected region of said side wall.
